(19) United States
(12) Patent Application Publication
(10) Pub. No.: US 2010/0328706 A1
(43) Pub. Date: Dec. 30, 2010

(54) SYSTEMS AND METHODS FOR MESSAGE BASED DETERMINATION OF PRINTER CAPABILITIES

(75) Inventor: KIYOSHI MIYAKE, Superior, CO (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Konica Minolta Systems Laboratory, Inc.

(21) Appl. No.: 12/495,340

(22) Filed: Jun. 30, 2009

(51) Int. Cl. G06F 3/12; H04W 4/12

(52) U.S. Cl. 358/1.15; 455/466

(57) ABSTRACT

Methods disclosed facilitate the obtaining of printer information using commonly available messaging techniques such as e-mail. In some embodiments, the method comprises receiving an email message, wherein the e-mail message includes at least one query requesting information about at least one sub-state of a printer, wherein the printer state is comprised of a plurality of sub-states and the at least one sub-state is one of the plurality of printer sub-states. Information pertaining to the at least one sub-state is obtained and a response is sent to the e-mail request. The e-mail response can include information pertaining to the at least one sub-state.

### BACKGROUND

1. Field of the Invention

The present invention relates to the field of printing and in particular, to systems and methods for determining the capability of printing devices using commonly available electronic messaging techniques.

2. Description of Related Art

Computer printers, which are ubiquitous in most modern organizations, permit the quick printing of stored documents. In organizations, which have a large number of physically distributed printers, it may difficult to determine the capabilities of various printers. For example, if a user in the organization wants a color printer capable of printing in high resolution, there is no easy way for the user to locate a printer with the desired capabilities. The problem is compounded if the user happens to be a visitor to that organizational facility. Typically, in such situations the user asks a system administrator for printer capability information to identify a printer with the desired capabilities. A printer driver for the identified printer is then installed on to the user's computer, which may also involve technical support staff to help install drivers on the user's computer, even for a one-time use of a specific printer. Finally, the user configures the identified printer appropriately before sending a print job to the printer.

The process described above to locate and utilize printers with specific capabilities can be cumbersome and lengthy. Therefore, the ability to quickly obtain printer capability would facilitate the utilization of printers, increase user productivity, and greatly simplify system administration. Accordingly, there is a need for systems and methods that facilitate the determination of printing device capability.

### SUMMARY

Consistent with embodiments disclosed herein, systems and methods for obtaining printer information are presented. In some embodiments, a method for obtaining printer state related information pertaining to at least one printer, wherein the printer state is comprised of a plurality of sub-states can comprise the processor-implemented steps of: receiving an email message, wherein the e-mail message comprises at least one query requesting information about at least one sub-state of the printer, wherein the at least one sub-state is one of the plurality of printer sub-states; obtaining information pertaining to the at least one sub state; and responding to the e-mail request, wherein the e-mail response comprises information pertaining to the at least one sub-state. The methods above may be performed in whole, or in part, by one or more of a printer or a print controller.

Embodiments also relate to software, firmware, and program instructions created, stored, accessed, or modified by processors using computer-readable media or computer-readable memory. These and other embodiments are further explained below with respect to the following figures.

### BRIEF DESCRIPTION OF THE DRAWINGS

FIG. 1 shows a block diagram of exemplary system for obtaining the capability of networked printers.

FIG. 2 shows a high-level block diagram of an exemplary printer wirelessly coupled to an exemplary computing device over a network.

FIG. 3 shows a flowchart illustrating steps in a method for processing status requests on a requesting device.

### DETAILED DESCRIPTION

In accordance with embodiments disclosed herein, systems and methods for automatically determining the capabilities of networked printing devices are presented.

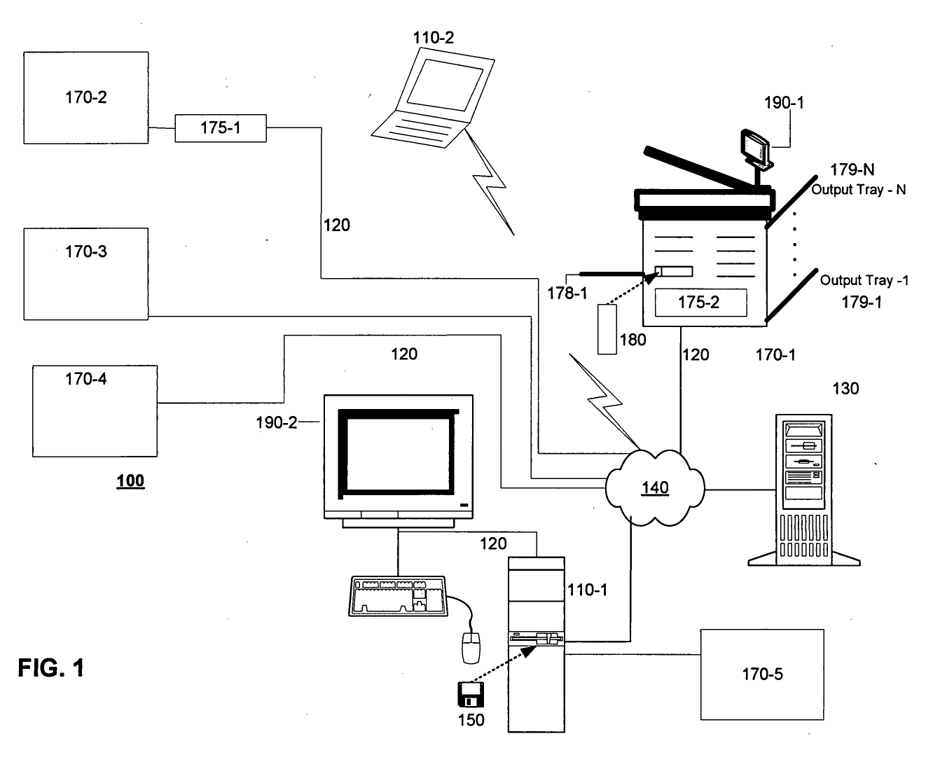

FIG. 1 shows a block diagram of exemplary system 100 for obtaining the capabilities of networked printers and for printing documents on the printers using messaging techniques. A computer software application for obtaining printer capability and facilitating printing on appropriately configured printers may be deployed on a network of computers and/or printers, as shown in FIG. 1 that are connected through communication links that allow information to be exchanged using conventional communication protocols and/or data port interfaces.

As shown in FIG. 1, exemplary system 100 includes computers or computing devices 110, printers 170, and server 130. Network 140 may include subnets, LANs, and/or WANs. Further, network 140 may also include modems, routers, repeaters, and other communication devices (not shown) that permit devices that are coupled to a network 140 to communicate with other devices over wired or wireless connections in accordance with the policies set by a network administrator.

In general, computing device 110 may be a computer workstation or desktop computer (e.g. 110-1), laptop or portable computer, handheld device, or any other mobile computing device (e.g. 110-2) capable of being used in a networked environment. Computing devices 110-1, 110-2, and/or server 130 may be capable of executing software (not shown) that facilitates obtaining the capabilities of individual printers and processing print requests for printers 170-1 through 170-5. Computing devices 110 and server 130 may contain removable media drives 150. Removable media drives 150 may include, for example, 3.5 inch floppy drives, CD-ROM drives, DVD ROM drives, CD±RW or DVD±RW drives, USB flash drives, Memory Sticks™, Secure Digital High Capacity (“SDHC”) cards, and/or any other removable media drives consistent with embodiments of the present invention. Portions of software applications may reside on removable media and be read and executed by computing devices 110-1, 110-2, and/or server 130 using removable media drive 150. In some embodiments, intermediate and final results and/or reports generated by applications may also be stored on removable media.

Printers 170 (such as printers 170-1 through 170-5) may be laser printers, ink jet printers, LED printers, plotters, and of various other types. From a functional perspective, printers 170 may take the form of computer printers, facsimile machines, digital copiers, multi-function devices, and/or various other devices that are capable of printing documents. In some embodiments, printers 170 may also support Management Information Bases (“MIB”s), which can be based on Requests for Comments (“RFC”s) issued by standard setting bodies. In some embodiments, the information in the MIB may pertain to descriptions, alerts, and/or status of various parameters tracked by printer 170. The information in the MIB may be seen as indicative of the state of the printer.

Connection 120 couples computing device 110, printers 170-1-170-5 to network 140. Connection 120 may be implemented as a wired or wireless connection using appropriate conventional communication protocols and/or data port interfaces. In general, connection 120 can be any communication channel that allows transmission of data between the devices. In one embodiment, for example, devices may be provided with data ports, such as USB™, SCSI, FIREWIRE™, and/or BNC ports for transmission of data through the appropriate connection 120. The communication links could be wireless links or wired links or any combination that allows communication between computing devices 110, server 130, print controller 175, and printers 170.

Printers 170 may be controlled by hardware, firmware, or software, or some combination thereof. Printers 170 may include one or more print controller boards 175, such as exemplary print controllers 175-1 and 175-2, which may control the operation of printers 170, and may also be capable of generating printer capability and status requests to printers 170. In some embodiments, printers 170 may be controlled by firmware or software resident on memory devices in print controllers 175. In general, print controllers 175 may be internal or external to printers 170. Exemplary print controllers 175 may also be controlled in part by software, including print servers, printer drivers, or other software, running on computing devices 110, and/or server 130.

Printers, such as exemplary printer 170-1, may also include consoles 190 such as consoles 190-1 and 190-2, or other interfaces to allow configuration options to be set, passwords and/or user identification and authentication information to be entered, printer capability, and other status messages to be displayed. In some embodiments, configuration options may be set or displayed using a display or user-interface on a monitor for a computer coupled to printers 170. For example, user interfaces to set one or more configuration options on printer 170-1 may be displayed on console 190-1. For example, the print resolution, document sizes, color options, and other configuration parameters may be user-configurable.

Users may also be able to log in to a printer 170 to perform administrative functions such as to enable software or firmware on printer 170 to perform various functions. In some embodiments, the log in process may require a password or other user-authentication mechanism. For example, a user may be able to specify input trays 178 and/or output trays 179, secure printing options, and the use of automatic document feeders to allow batch processing of documents. Printers 170 may have multiple input trays 178 and/or output trays 179. Output trays 179 can hold printed documents that have been processed by a printer. If a document is printed securely, the user may be asked to enter information on exemplary console 190 before the document is released from a secure output tray 179 and/or printed to an output tray 179.

A computer software application to obtain printer capability information for one or more printers 170 and/or print documents to printers 170 with appropriate capabilities may be deployed on any of the exemplary computers 110, server 130, print controllers 175, and/or printers 170, as shown in FIG. 1. For example, printer 170-1 may execute software or firmware that permits printer 170-1 to respond to message-based inquiries about its capabilities and accept print jobs for printing using message-based techniques. An independent application to respond to message-based printer capability inquiries and facilitate printing may also execute concurrently on printer 170-2. In another example, an application to respond to message-based printer capability inquiries and facilitate printing may be resident on print controller 175-1 and could be configured using computer 110 but operate on printer 170-1. In general, applications may execute in whole or in part on one or more computers 110, servers 130, print controllers 175, and/or printers 170 in the system. The embodiments described herein are exemplary only and other embodiments and implementations will be apparent to one of ordinary skill in the art. In some embodiments, message-based capability queries to printer 170 may be delivered via e-mail or any another appropriate protocol.

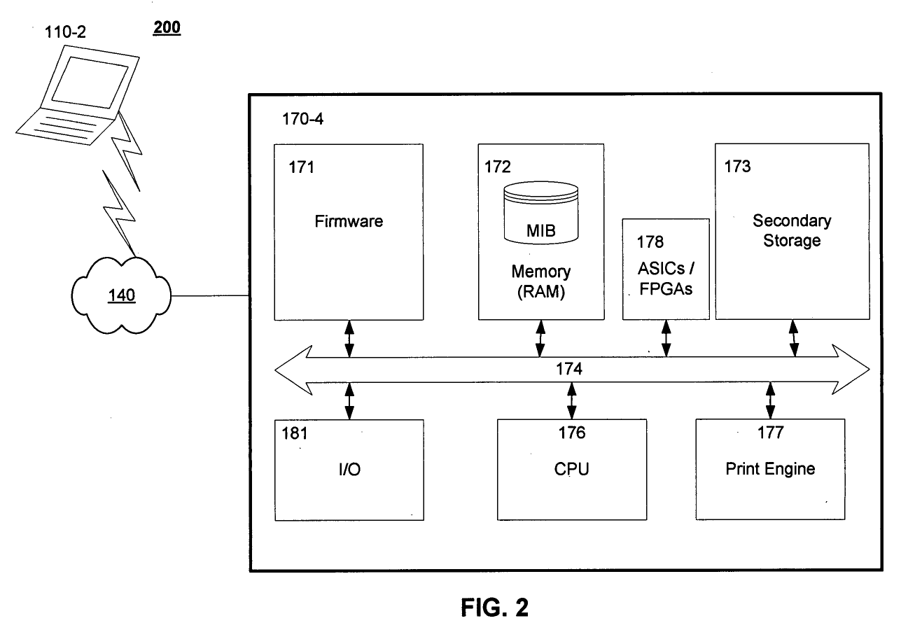

FIG. 2 shows a high-level block diagram of exemplary printer 170-4 coupled to computing device 110-2 wirelessly over network 140. Although, printer 170-4 has been shown and described in relation to FIG. 2, the description may also be applicable one or more of the other printers 170 shown in FIG. 1. Exemplary printer 170-4 may contain bus 174 that couples CPU 176, firmware 171, memory 172, input-output (“I/O”) module 181, print engine 177, and secondary storage device 173.

Exemplary printer 170-5 may also contain other Application Specific Integrated Circuits (ASICs), and/or Field Programmable Gate Arrays (FPGAs) 178 that are capable of executing portions of an application to respond to message-based capability inquiries, and to accept message-based requests to print or process documents, and routines to parse and process Simple Mail Transfer Protocol (“SMTP”) and Simple Network Management Protocol (“SNMP”) requests. In some embodiments, printer 170 may also be capable of executing software including, a printer operating system, SMTP clients and/or servers, SNMP clients and/or servers, mail servers, mail parsing and conversion routines, database management software, software to process message based printer capability requests and print job requests, printer status request processing and printer configuration software, as well as other appropriate application software.

Exemplary I/O module 181 may also permit communication with computer 110 over network 140. Information received from computers 110, server 130, and/or print controllers 175 may be processed by I/O module 181 and stored in memory 172. I/O module 181 may also notify CPU 176 about the communications. The communications may include data, commands, capability requests, status requests, SMTP requests and responses, SNMP and MIB requests and responses, job requests, and/or acknowledgements according to the communications protocol being used. CPU 176 may retrieve any information stored in memory 172 and process the information further.

Exemplary CPU 176 may be a general-purpose processor, a special purpose processor, or an embedded processor. CPU 176 can exchange data including control information and instructions with memory 172 and/or firmware 171. Memory 172 may be any type of Dynamic Random Access Memory (“DRAM”) such as but not limited to SDRAM, or RDRAM. Firmware 171 may hold instructions and data including but not limited to a boot-up sequence, pre-defined routines including routines for processing incoming requests and messages, composing outgoing responses and messages, routines for configuration management, routines for processing message based requests including routines for processing e-mail, SMTP messages, SNMP data, document processing, and other code. In some embodiments, code and data in firmware 171 may be copied to memory 172 prior to being acted upon by CPU 176. Data and instructions in firmware 171 may be upgradeable using one or more of computer 110, network 140, removable media coupled to printer 170, and/or secondary storage 173.

Exemplary CPU 176 may act upon instructions and data and provide control and data to ASICs/ FPGAs 178 and print engine 177 to generate printed documents. ASICs/FPGAs 178 may also provide control and data to print engine 177. FPGAs/ASICs 178 may also implement one of configuration management, message processing, and other print related algorithms.

Intermediate and final printable data, messages, printer status, and configuration information pertaining to one or more printers 170 may be stored in memory 172 or secondary storage 173. In some embodiments, “descriptions”—which provide information about printer capabilities, printer status information, alerts etc. may be stored in a Management Information Base (“MIB”) in memory 172. Information in the MIB as a whole may be viewed as describing the printer state. Information within the MIB pertaining to printer capabilities (sometimes called “Descriptions” in the Printer-MIB), status, and configuration can then be viewed as describing sub-states of the printer. Sub-state information can include information about a single capability, or a single configuration or status parameter; or it may include information about a set of capabilities, and/or sets of configuration and status parameters.

Note that information pertaining to some sub-states may be static (will not normally change), while others may be dynamic (changing). Descriptions convey information about the configuration and capabilities of the printer and its various sub-units. This information is largely static information and does not generally change during the operation of the system. However, descriptions can change if the printer is repaired, reconfigured, redeployed, or upgraded. For example, sub-state capability information such as the number of output trays will not change for a printer unless a tray is removed or another tray added. Therefore, such information can be considered static. On the other hand, the sub-state status information pertaining to an input tray—such as whether the tray is full or empty can change rapidly. Therefore, such information can be considered dynamic.

In some embodiments, the information in the MIB may relate to the status of various parameters tracked by printer 170. In some embodiments, the values of objects may be obtained initially when the printer is reset or started-up and then updated periodically. In some embodiments, an interrupt may be used to inform CPU 176 that an update is needed or than one or more tracked parameters have changed. The MIB for a printer, or printer-MIB, is specified in various standards documents (such as RFC 1759 and/or RFC 3805).

The MIB structure is typically organized in terms of a System MIB (such as RFC 1213), a Host MIB (such as RFC 2790), and a Printer MIB, in which the following exemplary MIB objects can be used to maintain and obtain printer status.

System MIB
1. SysDescr
2. SysName
3. SysLocation

Host MIB
1. hrPrinterStatus

Printer MIB
1. prtGeneralPrinterName
2. prtCoverStatus
3. prtCoverDescription
4. prtinputStatus
5. prtMarkerSuppliesDescription
6. prtMarkerSuppliesLevel
7. prtAlertDescription

Note that the description above is exemplary and for descriptive purposes only and may represent only a subset of the MIB objects available and/or tracked in a given printer. Various other MIB objects that are specified in the RFC may also be used according to the parameters tracked by a specific printer and/or the degree of printer status detail specified for retrieval. The System MIB lists several objects such as the exemplary SysDescr, SysName, and SysLocation objects listed above that specify the system description, system name and system location, respectively. The Host-MIB provides several status objects that can describe printer status in the context of two tables. For example, the hrPrinterStatus object can take on a range of values, where each value indicates a specific printer status. For example, the values may indicate whether the printer is busy, idle, warming up, or performing various other tasks.

The Printer MIB also includes several objects, such as the exemplary objects prtGeneralPrinterName, prtCoverStatus, prtCoverDescription, prtinputStatus, prtMarkerSuppliesDescription, prtMarkerSuppliesLevel, and prtAlertDescription. For the subset of objects listed above, object prtGeneralPrinterName specifies the printer name; object prtCoverStatus specifies the status of the printers covers and interlocks (i.e. whether any printer doors, trays, etc are open or closed); object prtCoverDescription specifies the manufacturer's name for the provided cover sub-mechanism; object prtinputStatus specifies the current status of the specified input sub-unit; object prtMarkerSuppliesDescription specifies the description of the marker (ink, toner etc) in the specified supply container or receptacle; object prtMarkerSuppliesLevel specifies the current level of the marker (if the specified supply is a container) or the remaining space (if this supply is a receptacle); and object prtAlertDescription, which further elaborates on a specified enumerated alert or provides information in the case where the alert code is classified as ‘other’ or ‘unknown’.

Additional information that may be obtained from the MIB for printer 170-4 may include the number of input and output trays, the maximum capacity of each tray, the maximum and minimum physical dimensions of media that can be used by the various trays, printing modes such as duplex, marking technology (e.g. laser, inkjet, thermal, etc), maximum resolution, number of colors supported, print speed, etc.

Note also that the specification of standards above is exemplary only and various other established or de-facto standards may also be used. In addition, ongoing updates to the standards, which are published and updated periodically by the Internet Society, the Internet Engineering Task Force, and other standard-setting organizations, may be used to update information contained in the MIB. The methods, systems, and apparatus disclosed herein may be easily adapted to any changes to the MIB structure, and/or to changes in information contained within the MIB as would be apparent to one of ordinary skill in the art.

As shown in FIG. 2, the MIB may be stored in memory 172. Portions of the MIB may be updated periodically or in response to specific requests. The MIB may be updated by CPU 176, which may periodically obtain status from various components and sub-assemblies of printer 170-5. For example, CPU 176 may monitor its interrupts, and read memory locations and/or registers on various components, and/or invoke applications to determine current status.

Note that exemplary printer 170-4 may be capable of providing the MIB information, when requests are made in accordance with SNMP over network 140. In some embodiments, a user request for printer capability information may be sent using e-mail and received by printer 170-5. SMTP and other mail processing routines executed by CPU 176 in printer 170-5 may parse the e-mail message to determine the nature of the request. Based on information in the e-mail, modules (routines and/or hardware) in printer 170-5 may query the MIB using SNMP to obtain description information pertaining to the capabilities of printer 170-5. The description information may be formatted and put into an e-mail response to the user. In some embodiments, the processing of SNMP and/or SMTP requests and responses may be performed by print controller 175.

Exemplary e-mail queries are shown below for illustrative purposes along with a comment (delimited by “/*” and “*/”) that briefly describes their functions. Various other formats and structure for the e-mail queries can be used as will be apparent to one of ordinary skill in the art.

| | |
|---|---|
| @QUERY - PRINT OPTION | /*Return available printing options*/. |
| @QUERY - STATUS | /*Return current printer and job status*/ |
| @QUERY - CAPABILITY | /*Return printer capability information*/ |
| @QUERY | /*Return all (of the above) information*/ |
| @PRINT | /*Print email body and/or attachments*/ |
| @HELP | /*Return “Help” information*/ |

The queries above may appear in the message body or in the subject line and the SMTP server on printer 170-4 or print controller 175 may be appropriately configured to process and respond to queries of the type shown above. For example, as shown above, the syntax for the command may comprise the delimiter “@” followed by the command “QUERY” and a term indicating the nature of the query. The printer may also be configured to support other options to facilitate easier use. For example, e-mails sent to the printer that are unrecognizable may result in a response with “Help” information. Similarly, if no sub-option, or an unrecognized or incoherent sub-option is specified with “@QUERY” then the printer may interpret the query as a “@QUERY” command.

Additional examples pertaining to various individual commands present in some embodiments are shown below. For example, when an e-mail message is sent to printer 170-5 or print controller 175 with the command “@QUERY—CAPABILITY” the response may return the various capabilities of printer 170-5.

```
Message:
@QUERY - CAPABILITY
Response:
[CAPABILITY]
    - SPEED = 20ppm
    - COLOR MODE = BW / COLOR
    - DOCUMENT FORMAT = TEXT, PDF, WORD,
                        EXCEL,
                        POWERPOINT, XPS,
                        TIFF, JPEG,
                        POSTSCRIPT..
    - EMAIL PRINT = Body text and Attachments
    - PAPER SIZE = A5 − A3/LGR
    - DUPLEX = YES
    - STAPLE = YES
    - PUNCH = NO
    - SECURE PRINT = YES
```

As shown above, printer capabilities returned may include printer speed, available color modes, document formats accepted by the printer, e-mail printing, paper sizes, duplex modes, stapling, hole punch and secure printing options.

If the capabilities returned by the printer are deemed adequate by the user then the user may send another e-mail message to the printer to request printing of the job. In some embodiments, printers 170 may support additional queries, for example by using the command “@QUERY—PRINT OPTION” a user can determine printing options supported by the printer that may be included as part of the print request.

```
[PRINT OPTIONS]
  - @PMCMD DOCUMENT FORMAT = AUTO* /PDF /WORD /
  TIFF /...
  - @PMCMD PRINT DATA = ATTACHMENT / BODY / ALL* /...
  - @PMCMD PAGE RANGE = ALL* / (“x-y”, “x, y, z”) /...
  - @PMCMD PAPER SIZE = A4 / LTR* / A3 / LGR (A4*)/...
  - @PMCMD COLOR MODE = BW* / COLOR (BW*) / ...
  - @PMCMD COPIES = 1* - 100 / ...
  - @PMCMD DUPLEX = OFF* / AUTO / LEFT BIND / TOP BIND/ ...
  - @PMCMD STAPLE = OFF* / TOP LEFT / TOP RIGHT / ...
  - @PMCMD SECURE MODE = OFF* / HOLD/
  HOLD+PASSWORD /
  - @PMCMD NOTIFICATION = YES* / NO / ...
```

As indicated above, the response to the query command indicates that printer 170 supports specification of various options in a print command including the document format of the document, portions of the e-mail sent to printers 170 or print controller 175 to be printed, page ranges to print, paper size to be used, color mode, number of copies of the document to be printer, duplex options, stapling, secure mode printing, and notifications regarding job status. In secure mode, printer 170-4 may hold a print job until the user enters user-id and/or password information using a console 190 coupled to printer 170-5. In some embodiments, commonly used options may be specified as default options—so that the user can omit the specification of options that are compatible with the print job being sent to printer 170. In the example above, some default options are indicated in the response to the query with an asterisk (“*”). In some embodiments, an “AUTO” option is available—when the “AUTO” option is selected the printer may use data from the print job and/or internal sensors to automatically change configuration settings. For example, document formats and paper size may be automatically determined by the printer.

The user may specify one or more of the above print options in an e-mail message sent to the printers 170. The receiving printer 170 can then print the job as specified in the e-mail. An exemplary print command is shown below.

```
@PRINT
    @PMCMD PRINT DATA = BODY+ATTACHMENT
    @PMCMD COLOR MODE = COLOR
    @PMCMD COPY = 5
    @PMCMD STAPLE = TOP LEFT
```

As shown above, the print command indicates that both the body of the e-mail and all attachments to the e-mail are to be printer by receiving printer 170. Five copies of the job are to be printed in color and each copy is to be stapled in the top-left corner. In some embodiments, commands to printer 170 may be filtered prior to printing so that they will not appear in the printed document.

Printers 170 may also support various other queries including queries for printer and/or job status. For example, in response to the command “@QUERY—STATUS” printer 170 may respond with:

```
[STATUS]
  -  DEVICE STATUS : Printing
  -  DETAILS :
      ◯  “Job3” - Page 5 of 10 pages
  - PRINT HISTORY
    - Job1 (100page) - Completed (2009/1/3/12:30)
    - Job2 (5page) - Canceled (2009/1/3/13:00)
```

Various other options may also be available to obtain printer and/or job status. For example, if the user print command includes the “NOTIFICATION” option—then the user may automatically notified via e-mail when the print job has completed, or if there is an error that temporarily prevents completion. In some embodiments, a “PREVIEW” command may also be available which may direct printer 170 to send a preview of the document to be printed to the user via e-mail.

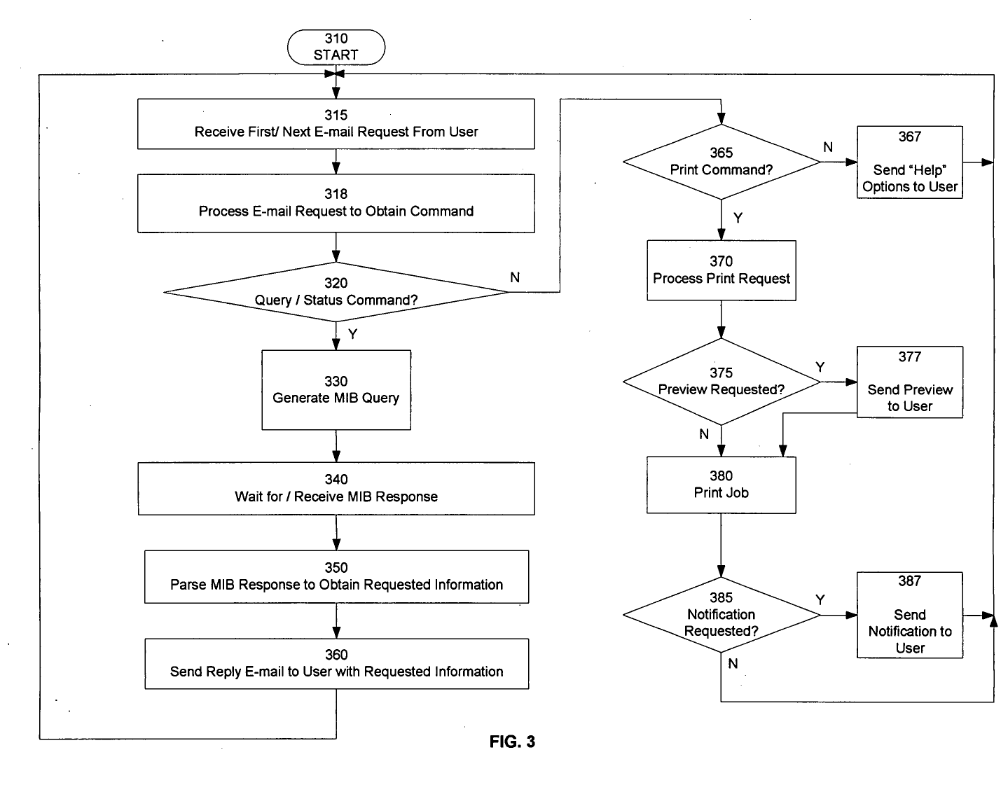

FIG. 3 shows a flowchart illustrating steps in a method 300 for processing messaging requests. In some embodiments, portions of the method may be performed by printer 170 and/or print controller 175. For the purposes of this discussion, the messaging request is assumed to be an e-mail request although other electronic messaging schemes may also be used. In general, the method may be performed by any printing device 170 or print controller 175 that is capable of receiving, processing, and responding to e-mail messages, which may include embedded commands. The process starts in step 310, where hardware on printer 170 and/or print controller 175 may be initialized and appropriate firmware and software may be loaded into memory 172.

In step 315, the first or next e-mail message may be received from a user. In some embodiments, an SMTP server or mail server in printer 170 or print controller 175 may receive the e-mail message. Next, in step 318, the e-mail request may be parsed to extract commands within the e-mail message. In step 320, the extracted commands may be checked to determine if the command is a query or status command.

If the command is a query or status command (“Y” in step 320) then, in step 330, a MIB query may be generated to request status information from printer 170. In some embodiments, one or more “callback functions” may be used by the SMTP server to generate the MIB queries. In some embodiments, the callback functions may invoke or use appropriate SNMP Application Programming Interfaces (“API”s) to generate the MIB queries and receive responses. In some embodiments, printer 170 may process the printer status request and obtain current status information from the MIB structure in printer memory 172.

After processing the printer status request, printer 170 and/or print controller 175 may respond with current printer status information in the form of appropriately formatted MIB data. In step 340, the MIB response may be received. Next, in step 350, the MIB response may be parsed to obtain information requested by the user. In step 360, a reply e-mail including the information requested by the user may then be sent to the user. The process then returns to step 315 to begin a subsequent iteration. Note that if the query is for “help” or for other information that is available without an MIB request, then printer 170 or print controller 175 may respond directly via reply e-mail with the requested information without generating an MIB query.

If the command is not a query or status command (“N” in step 320) then, in step 365, the command may be checked to determine if the command is a print command. If the command is a print command (“Y” in step 365) then, in step 370, the print request may be processed in accordance with the options specified in the command. If the command is not a print command (“N” in step 365) (and if no other command types are available) then the command may be deemed unrecognized and “Help” options may be sent to the user in step 367. The algorithm then returns to step 315 to begin a subsequent iteration.

In step 375, the print command may be parsed to determine if one or more print options are present. For example, the print command may be parsed to determine if a print preview, job notification, or other options have been enabled by the user. If a print preview has been requested by the user (“Y” in step 375), then, in step 377, a preview may be generated and sent to the user. In some embodiments, the process may then return to step 380. If no preview has been requested (“N” in step 375), then the algorithm proceeds to step 380.

In step 380, the print job may be printed in accordance with options specified in the command, or using default options for unspecified options. In step 385, if a job notification has been requested (“Y” in step 385), then the print job may be monitored and event-based notifications may be sent to the user in step 387. For example, the user may be notified when the job is complete, or about any error conditions preventing completion, or when some specified number of pages or copies have been printed. If secure printing has been enabled then the user may be prompted via e-mail to retrieve the job. If no job notification has been requested (“N” in step 385), or the requested notification has already been sent (in step 387) then the algorithm returns to step 315 to begin a subsequent iteration.

Using disclosed embodiments, an employee, or an authorized visitor to an organizational facility may be able to print documents easily without the need to install printer drivers and other software. The user may simply send an e-mail message to an appropriately configured printer 170 to obtain state or sub-state information, including information about configuration, the capabilities of the printer, status information, print options, and help with commands. Jobs may sent to printer 170 for printing using specified configuration settings, and the sender can receive notifications about the print job status. In some embodiments, the tasks specified above may be performed by sending an e-mail message from a wireless handheld device such as a smart phone, Personal Data Assistant (“PDA”), netbook, and/or other computing devices that have e-mail capabilities.

In some embodiments, printer 170 may be configured to recognize “user groups” from e-mail addresses and may respond to capability queries based on information about capabilities available to the user group. For example, certain user groups may be prevented from utilizing specified printers in the organization. For example, in situations where printer 170-1 determines that the e-mail originates from a member of a user group that is prohibited from using printer 170-1, printer 170-1 may respond to requests by indicating that it is “unavailable”. In other situations, a color printer may respond to a member of a specified user-group with a message that shows black and white print options without showing color printing options. In general, the printer may redact some sub-state information, or otherwise alter its response, if it determines that there are restrictions associated with the sender's user group. Accordingly, in some embodiments, printers 170 may be configured using software to enforce organizational policies pertaining to device usage.

In some embodiments, a program for conducting the process described in algorithms 300 can be recorded on computer-readable media 150 or computer-readable memory. These include, but are not limited to, Read Only Memory (ROM), Programmable Read Only Memory (PROM), Flash Memory, Non-Volatile Random Access Memory (NVRAM), or digital memory cards such as secure digital (SD) memory cards, Compact Flash™, Smart Media™, Memory Stick™, and the like. In some embodiments, one or more types of computer-readable media may be coupled to printer 170. In certain embodiments, portions of a program to implement the systems, methods, and structures disclosed may be delivered over network 140.

Other embodiments of the present invention will be apparent to those skilled in the art from consideration of the specification and practice of one or more embodiments of the invention disclosed herein. It is intended that the specification and examples be considered as exemplary only, with a true scope and spirit of the invention being indicated by the following claims.

What is claimed is:

1. A processor implemented method for obtaining printer state related information pertaining to at least one printer, wherein the printer state is comprised of a plurality of sub-states, the method comprising the processor-implemented steps of:
receiving an email message, wherein the e-mail message comprises at least one query requesting information about at least one sub-state of the printer, wherein the at least one sub-state is one of the plurality of printer sub-states;
obtaining information pertaining to the at least one sub-state; and
responding to the e-mail request, wherein the e-mail response comprises information pertaining to the at least one sub-state.

2. The processor implemented method of claim 1, wherein obtaining information pertaining to the at least one sub-state comprises:
parsing the e-mail message to extract information pertaining to the at least one sub-state;
generating a MIB request for information pertaining to the at least one sub-state, wherein the MIB request is based on the extracted information; and
parsing the response to the MIB request to extract requested information pertaining to the at least one sub-state.

3. The processor implemented method of claim 1, wherein information pertaining to the at least one sub-state comprises at least one of
printer capability information,
printer configuration information, or
printer status information.

4. The processor implemented method of claim 1, wherein the method is performed on at least one of:
a printer;
a print controller; or
a printer coupled to a print controller.

5. The processor-implemented method of claim 1, wherein the received e-mail message is sent from a computing device.

6. The processor-implemented method of claim 5, wherein the computing device is a smart phone.

7. The processor-implemented method of claim 1, wherein responding to the e-mail request comprises:
determining a user-group associated with the sender of the received e-mail message;
ascertaining if any restrictions associated with the user group apply to the information pertaining to the at least one sub-state;
redacting information from the information pertaining to the at least one sub-state in accordance with the restrictions associated with the user group; and
responding to the e-mail request using the redacted information.

8. The processor-implemented method of claim 1, wherein responding to the e-mail request comprises sending help information to sender, if the received e-mail message is incoherent.

9. A computer-readable medium including program instructions, which when executed by a computer, perform steps in a method for obtaining printer state related information pertaining to at least one printer, wherein the printer state is comprised of a plurality of sub-states, the steps comprising:
receiving an email message, wherein the e-mail message comprises at least one query requesting information about at least one sub-state of the printer, wherein the at least one sub-state is one of the plurality of printer sub-states;
obtaining information pertaining to the at least one sub-state; and
responding to the e-mail request, wherein the e-mail response comprises information pertaining to the at least one sub-state.

10. The computer-readable medium of claim 9, wherein obtaining information pertaining to the at least one sub-state comprises:
parsing the e-mail message to extract information pertaining to the at least one sub-state;
generating a MIB request for information pertaining to the at least one sub-state, wherein the MIB request is based on the extracted information; and
parsing the response to the MIB request to extract requested information pertaining to the at least one sub-state.

11. The computer-readable medium of claim 9, wherein information pertaining to the at least one sub-state comprises at least one of
printer capability information,
printer configuration information, or
printer status information.

12. The computer-readable medium of claim 9, wherein the method is performed on at least one of:
a printer;
a print controller; or
a printer coupled to a print controller.

13. The computer-readable medium of claim 9, wherein the received e-mail message is sent from a computing device.

14. The computer-readable medium of claim 13, wherein the computing device is a smart phone.

15. The computer-readable medium of claim 9, wherein responding to the e-mail request comprises:
determining a user-group associated with the sender of the received e-mail message;
ascertaining if any restrictions associated with the user group apply to the information pertaining to the at least one sub-state;
redacting information from the information pertaining to the at least one sub-state in accordance with the restrictions associated with the user group; and
responding to the e-mail request using the redacted information.

16. The computer-readable medium of claim 9, wherein responding to the e-mail request comprises sending help information to sender, if the received e-mail message is incoherent.

17. A computer-readable memory including program instructions, which when executed by a computer, perform steps in a method for obtaining printer state related information pertaining to at least one printer, wherein the printer state is comprised of a plurality of sub-states, the steps comprising:
receiving an email message, wherein the e-mail message comprises at least one query requesting information about at least one sub-state of the printer, wherein the printer state is comprised of a plurality of sub-states and the at least one sub-state is one of the plurality of printer sub-states;
obtaining information pertaining to the at least one sub-state; and
responding to the e-mail request, wherein the e-mail response comprises information pertaining to the at least one sub-state.

18. The computer-readable memory of claim 17, wherein obtaining information pertaining to the at least one sub-state comprises:
parsing the e-mail message to extract information pertaining to the at least one sub-state;
generating a MIB request for information pertaining to the at least one sub-state, wherein the MIB request is based on the extracted information; and
parsing the response to the MIB request to extract requested information pertaining to the at least one sub-state.

19. The computer-readable memory of claim 17, wherein information pertaining to the at least one sub-state comprises at least one of
printer capability information,
printer configuration information, or
printer status information.

20. The computer-readable memory of claim 17, wherein the method is performed on at least one of:
a printer;
a print controller; or
a printer coupled to a print controller.

21. The computer-readable medium of claim 17, wherein the received e-mail message is sent from a smart phone.
